(19) United States
(12) Patent Application Publication
(10) Pub. No.: US 2025/0019922 A1
(43) Pub. Date: Jan. 16, 2025

(54) Construction Machine

(71) Applicant: Hitachi Construction Machinery Co., Ltd, Taito-ku, Tokyo (JP)

(72) Inventors: Hajime OKANO, Nagareyama-shi, Chiba (JP); Yuuji MURAYAMA, Tsuchiura-shi, Ibaraki (JP); Yoshitaka YANASE, Tsuchiura-shi, Ibaraki (JP)

(21) Appl. No.: 18/714,853

(22) PCT Filed: Mar. 21, 2023
(86) PCT No.: PCT/JP2023/011037

§ 371 Date: May 30, 2024

(30) Foreign Application Priority Data
Mar. 30, 2022 (JP) 2022-055014

(51) Int. Cl. E02F 3/32; E02F 3/42; E02F 9/02; E02F 9/08; E02F 9/12; E02F 9/22

(52) U.S. Cl. CPC E02F 3/32; E02F 3/425; E02F 9/02; E02F 9/0883; E02F 9/123; E02F 9/2228; E02F 9/2275; E02F 9/2289; E02F 9/2292; E02F 9/2203; E02F 9/2296

(57) ABSTRACT

A manifold (33) of a closed-circuit control valve device (32) disposed rearward of a left revolving hydraulic motor (8) includes a valve attachment area (33E) provided at a central portion of the manifold (33) in the right-and-left direction and including a control valve (34) mounted therein and a pipe attachment area (33F) provided outward of the valve attachment area (33E) in the right-and-left direction and including a closed-circuit actuator side pipe (47) mounted therein. A manifold (42) of an open-circuit control valve device (41) disposed rearward of a right revolving hydraulic motor (9) includes a valve attachment area (42E) provided at a central portion of the manifold (42) in the right-and-left direction and mounted a control valve (43) and a pipe attachment area (42F) provided outward of the valve attachment area (42E) in the right-and-left direction and mounted an open-circuit actuator side pipe (48).

### TECHNICAL FIELD

The present invention relates to a construction machine such as a hydraulic excavator, and more particularly, to a construction machine with a plurality of control valves controlling a hydraulic actuator.

### BACKGROUND ART

A hydraulic excavator, serving as a representative type of construction machine, generally includes a self-propelled lower traveling structure, an upper revolving structure provided rotatably on the lower traveling structure via a revolving device and a working mechanism provided at a front portion of the upper revolving structure. The hydraulic excavator is provided with hydraulic actuators such as a traveling hydraulic motor allowing the lower traveling structure to travel, a revolving hydraulic motor of the revolving device rotating the upper revolving structure, a boom cylinder, an arm cylinder and a bucket cylinder operating the working mechanism. Further, the upper revolving structure of the hydraulic excavator includes a revolving frame supported rotatably on the lower traveling structure via the revolving device, an engine as a prime mover provided on a rear side of the revolving frame, a hydraulic pump provided on the engine, and a control valve device located forward of the engine, provided on the revolving frame and controlling the hydraulic actuator. Also, the hydraulic excavator includes a plurality of pump side pipes connecting the hydraulic pump and the control valve device, and a plurality of actuator side pipes connecting the control valve device and a plurality of actuators (the traveling hydraulic motor of a traveling device, each hydraulic cylinder of the working mechanism and the revolving hydraulic motor of the revolving device).

In operation, the hydraulic excavator allows the engine to drive the hydraulic pump to supply hydraulic oil (pressurized oil) discharged from the hydraulic pump to the hydraulic actuator via the control valve device and each of the pipes. This mechanism allows the hydraulic excavator to operate the traveling device, the revolving device, and the working mechanism.

In recent years, even hydraulic excavators have been desired

to reduce energy loss (flow rate loss, pressure loss) for energy conservation. Illustrative examples of a hydraulic system supplying hydraulic oil from a hydraulic pump to a hydraulic actuator include a closed circuit system connecting an exclusive closed-circuit hydraulic pump to the hydraulic actuator and supplying and discharging hydraulic oil between the hydraulic actuator and the exclusive closed-circuit hydraulic pump (Patent Document 1).

### PRIOR ART DOCUMENT

### Patent Document

Patent Document 1: Japanese Patent Laid-Open No. 2015-048899 A

### SUMMARY OF THE INVENTION

A closed circuit system requires two closed-circuit pipes circulating hydraulic oil between a hydraulic pump and a hydraulic actuator. Specifically, for example, the operation of four hydraulic actuators of a hydraulic excavator: a boom cylinder, an arm cylinder, a bucket cylinder, and a revolving hydraulic motor in a closed circuit system needs at least four closed-circuit hydraulic pumps and eight closed-circuit pipes. In addition, a plurality of open-circuit pipes for operating a traveling hydraulic motor and its associated instruments are required even in a drive system of a traveling device configured by an open circuit pump, as disclosed in Patent Document 1.

Therefore, numerous hydraulic pipes are present on the periphery of a control valve device. Unfortunately, such a pipe arrangement fails to easily secure a space on the periphery of the control valve device for detaching and attaching and maintaining each control valve mounted on the control valve device and a revolving hydraulic motor disposed near the control valve device, resulting in a lower operational efficiency for each operational work.

In view of the above-described problems of conventional technologies, an object of the present invention is to provide a construction machine capable of improving the operational efficiency for detaching and attaching and maintaining control valves, a revolving hydraulic motor and others by securing a space for performing operational work on the periphery of a control valve device.

A construction machine according to the present invention includes: a self-propelled lower traveling structure; an upper revolving structure provided rotatably on the lower traveling structure via a revolving device; and a working mechanism provided rotatably at a front portion of the upper revolving structure and rotated by a hydraulic cylinder, characterized in that the revolving device includes: a revolving ring supporting rotatably the upper revolving structure on the lower traveling structure; and a revolving hydraulic motor provided on the upper revolving structure and revolving the upper revolving structure on the lower traveling structure along the revolving ring, characterized in that the upper revolving structure includes: a revolving frame supported rotatably on the lower traveling structure via the revolving ring; a prime mover provided on a rear side of the revolving frame; a hydraulic pump driven by the prime mover; a control valve device located forward of the prime mover, provided on the revolving frame and composed of a plurality of control valves mounted on a manifold; a plurality of pump side pipes connecting the hydraulic pump and the control valve device; and a plurality of actuator side pipes connecting the control valve device, the hydraulic cylinder of the working mechanism and the revolving hydraulic motor of the revolving device, characterized in that the control valve device includes the plurality of control valves located on a front surface of the manifold facing forward and a plurality of pipe joint ports located on the front surface of the manifold and connected to the plurality of actuator side pipes, and is disposed rearward of the revolving hydraulic motor such that the front surface of the manifold faces the revolving hydraulic motor, and the front surface of the manifold includes a valve attachment area provided at a central portion of the manifold in the right-and-left direction and mounted the plurality of control valves and a pipe attachment area provided outward of the valve attachment area in the right-and-left direction and provided the pipe joint ports mounted the plurality of actuator side pipes.

According to the present invention, a space for performing operational work can be secured on the periphery of a control valve device to successfully improve the operational efficiency for detaching and attaching and maintaining control valves, a revolving hydraulic motor and others.

### BRIEF DESCRIPTION OF THE DRAWINGS

FIG. 1 is a right side view showing a hydraulic excavator according to an embodiment of the present invention.

FIG. 2 is a plan view of an upper revolving structure without a housing.

FIG. 3 is a plan view of an enlarged essential portion in FIG. 2.

FIG. 4 is a cross-sectional view of the upper revolving structure, viewed along arrows IV-IV in FIG. 2.

FIG. 5 is a hydraulic circuit diagram of the hydraulic excavator.

### MODE FOR CARRYING OUT THE INVENTION

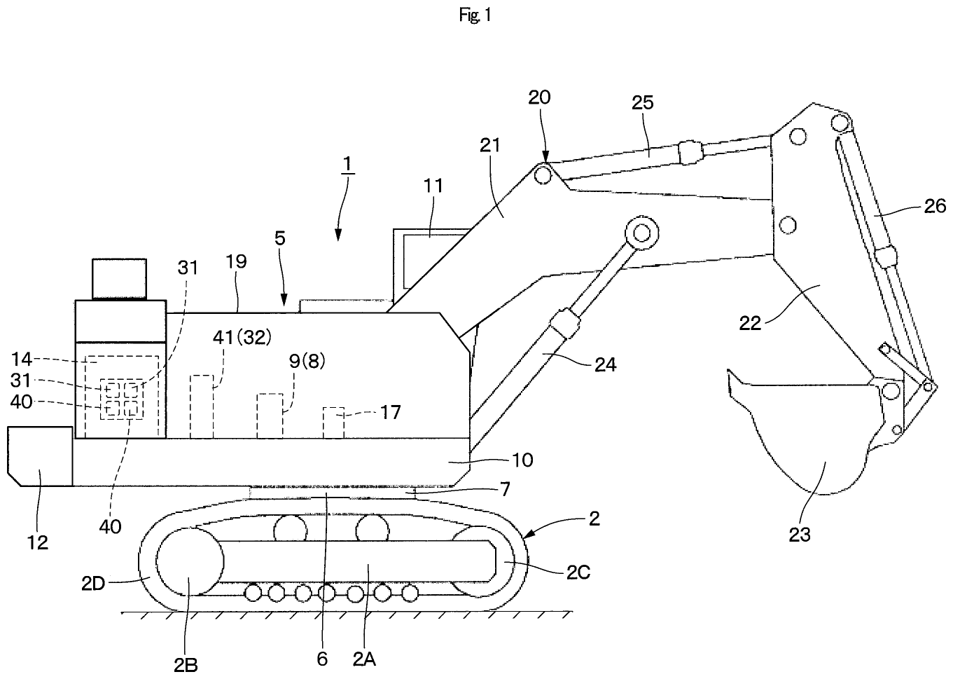

A representative type of construction machine according to an embodiment of the present invention, by taking the case of a hydraulic excavator, will be explained in detail with reference to FIGS. 1 to 5.

In FIG. 1, a hydraulic excavator 1 serving as representative type of construction machine is used to perform excavating work of sand and earth. The hydraulic excavator 1 includes a crawler-type self-propelled lower traveling structure 2, an upper revolving structure 5 provided rotatably on the lower traveling structure 2 and constituting a vehicle body together with the lower traveling structure 2, and a working mechanism 20 provided at a front portion of the upper revolving structure 5. The hydraulic excavator 1 performs excavating work of sand and earth, using the working mechanism 20.

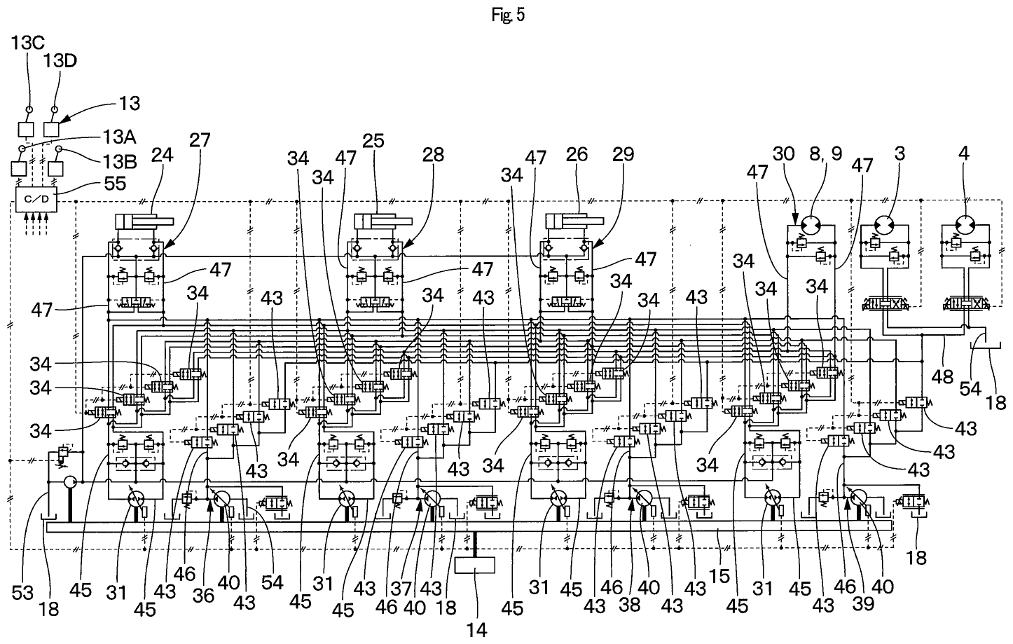

The lower traveling structure 2 includes a truck frame 2A, a drive wheel 2B provided on either right or left side of the truck frame 2A, an idler wheel 2C provided on either right or left side of the truck frame 2A and opposite the drive wheel 2B in the front-rear direction, and a crawler belt 2D looped around the drive wheel 2B and the idler wheel 2C (each shown only on the right side). The left drive wheel is rotatively driven by a left traveling hydraulic motor 3 (see FIG. 5). The right drive wheel 2B is rotatively driven by a right traveling hydraulic motor 4 (see FIG. 5). The traveling hydraulic motors 3, 4 constitute a hydraulic actuator.

A revolving device 6 is a device revolving the upper revolving structure 5 on the lower traveling structure 2. The revolving device 6 includes a revolving ring 7 (see FIG. 1) composed of a large-diameter bearing rotatably supporting the upper revolving structure 5 on the lower traveling structure 2 and one or more, for example, two revolving hydraulic motors 8, 9 (see FIG. 5) provided on the upper revolving structure 5 and revolving the upper revolving structure 5 on the lower traveling structure 2 along the revolving ring 7. The two revolving hydraulic motors 8, 9 constitute a hydraulic actuator.

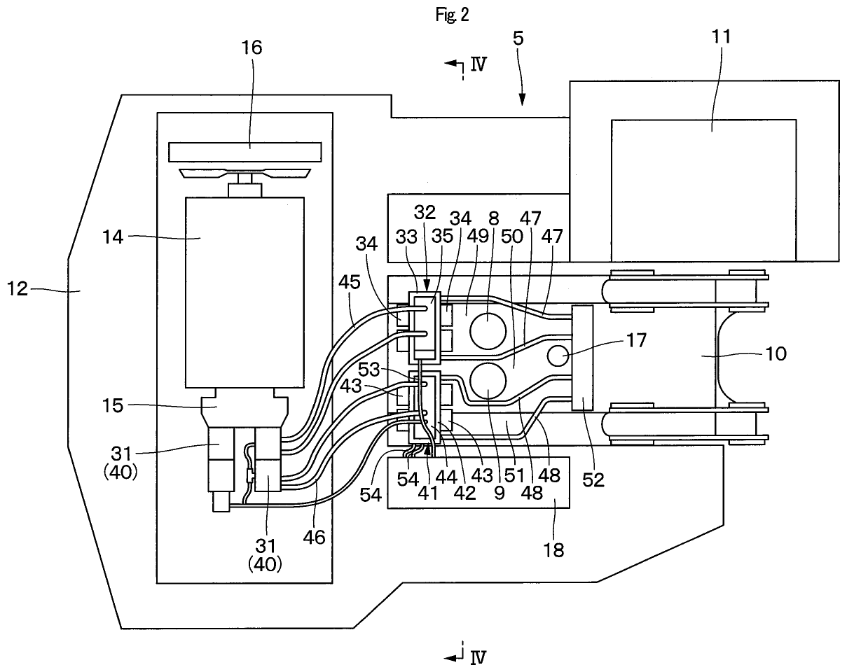

The two revolving hydraulic motors 8, 9 are provided on a revolving frame 10 via a reduction device (not shown). As shown in FIG. 2, the two revolving hydraulic motors 8, 9 are disposed side by side in the right-and-left direction between a later-described center joint 17, and a closed-circuit control valve device 32 and an open-circuit control valve device 41.

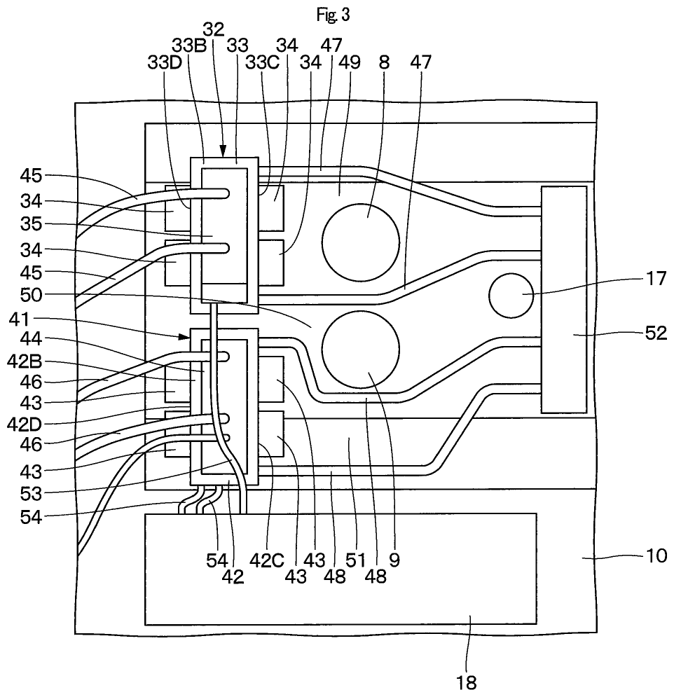

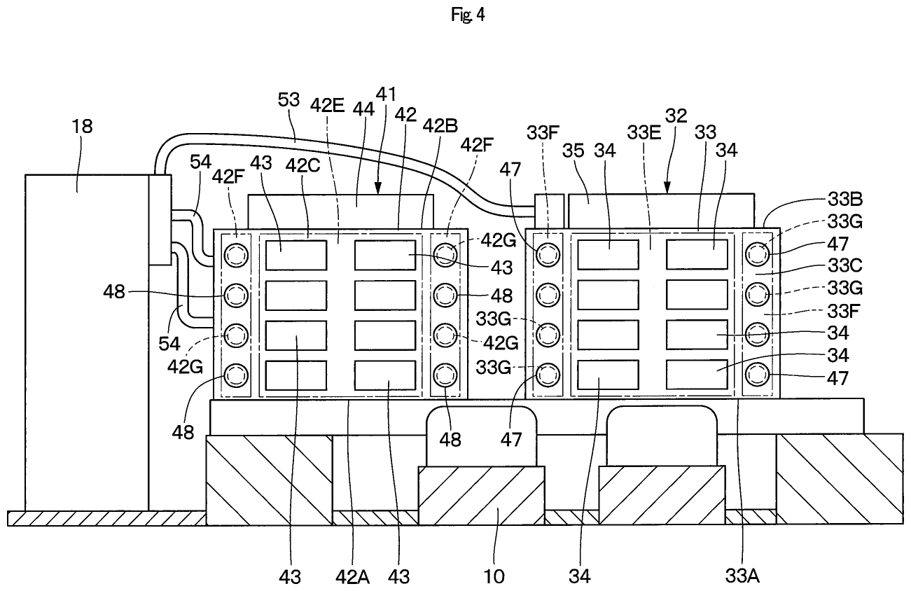

As shown in FIG. 3, the left revolving hydraulic motor 3 is disposed forward of the closed-circuit control valve device 32. Specifically, the left revolving hydraulic motor 8 is disposed forward of a later-described valve attachment area 33E located at a central portion of a manifold 33 in the right-and-left direction (see FIG. 4), that is in a later-described first space 49 (see FIG. 3). The right revolving hydraulic motor 9 is disposed forward of the open-circuit control valve device 41. Specifically, the right revolving hydraulic motor 9 is disposed forward of a pipe attachment area 42F (see FIG. 4) located on a left outer side of a manifold 42, that is in a later-described second space 50 (see FIG. 3). A later-described closed-circuit actuator side pipe 47 is connected to the two revolving hydraulic motors 8, 9.

As shown in FIGS. 1 and 2, the upper revolving structure 5 includes a revolving frame 10 composed of a support structural body and including the working mechanism 20 provided on a front side thereof, a cab 11 mounted on a left front side of the revolving frame 10 and forming an operator's room therein, a counterweight 12 mounted at a rear portion of the revolving frame 10 and taking a weight balance with the working mechanism 20, and a housing 19 located between the cab 11 and the counterweight 12 and accommodating a later-described engine 14 and so on mounted on the revolving frame 10.

Herein, an operator's seat for an on-board operator to be seated (not shown) is provided inside the cab 11. An operating device 13 operating the hydraulic excavator 1 (see FIG. 5) is provided forward of and on the left and right sides of the operator's seat. The operating device 13 is illustrated as one example of a target to be operated and a lever operation combined, and configured to include a left control lever 13A for operating the revolving hydraulic motors 8, 9 and a later-described arm cylinder 25, a right control lever 13B for operating a later-described boom cylinder 24 and a bucket cylinder 26, and left and right traveling levers/pedals 13C, 13D operating the left traveling hydraulic motor 3 and the right traveling hydraulic motor 4, respectively.

The operating device 13 is connected to a later-described controller 55 via signal lines and the like. An operator can operate the operating device 13 to revolve the upper revolving structure 5, rotate the working mechanism 20 and allow the lower traveling structure 2 to travel.

As shown in FIG. 2, an engine 14, as a prime mover, is located forward of the counterweight 12 and provided on the revolving frame 10. The engine 14 is configured as a diesel engine, for example. One engine 14 is transversely provided to extend in the right-and-left direction on a rear side of the revolving frame 10. For example, a plurality of closed-circuit hydraulic pumps 31, a plurality of open-circuit hydraulic pumps 40 and others are mounted on the right side of the engine 14 via a power transmission device 15. The power transmission device 15 has a plurality of gear mechanisms (not shown) transmitting a rotation of an output shaft of the engine 14 and the respective gear mechanisms are connected to the plurality of closed-circuit hydraulic pumps 31, the plurality of open-circuit hydraulic pumps 40 and others. A heat exchanger 16 composed of a radiator, an oil cooler, a condenser and other elements is disposed on the left side of the engine 14.

The prime mover may be a single electric motor, or a hybrid type prime mover composed of a diesel engine and an electric motor combined. Meanwhile, the prime mover may be longitudinally provided to extend in the front-rear direction of the upper revolving structure 5. In addition, such two prime movers may be disposed side by side in the right-and-left direction.

A center joint 17 is located at the center of the revolving ring 7 of the revolving device 6 and provided between the lower traveling structure 2 and the upper revolving structure 5. The center joint 17 forms a joining part allowing hydraulic oil and electricity (electric signals) to circulate between the lower traveling structure 2 and the upper revolving structure 5, even with the upper revolving structure 5 revolving relative to the lower traveling structure 2. An open-circuit actuator side pipe 48 and other elements are connected to the center joint 17.

A hydraulic oil tank 18 is disposed on the revolving frame 10 to reserve hydraulic oil to be supplied to the open-circuit hydraulic pump 40 and the like. The hydraulic oil tank 18 is formed as a rectangular-shaped container extending in the front-rear direction, for example, and disposed on the right side of the revolving frame 10. Specifically, as shown in FIG. 3, the hydraulic oil tank 18 is located adjacent to the right side of a later-described open-circuit control valve device 41 and away from the closed-circuit control valve device 32. In addition, one closed-circuit tank side pipe 53 extending from the closed-circuit control valve device 32 and a plurality of open-circuit tank side pipes 54 extending from an open-circuit control valve device 41 are connected to the hydraulic oil tank 18.

The housing 19 is provided on the revolving frame 10 so as to cover apparatuses including the revolving hydraulic motors 8, 9, the engine 14, the heat exchanger 16, the hydraulic oil tank 18, the closed-circuit hydraulic pumps 31, and the open-circuit hydraulic pumps 40. The housing 19 is formed to be boxy, for example, by mounting iron plates and other materials on frameworks composed of a plurality of steel materials.

As shown in FIG. 1, the working mechanism 20 includes a boom 21 mounted rotatably on a front side of the revolving frame 10, an arm 22 mounted rotatably on a tip end side of the boom 21, and a bucket 23 mounted rotatably on a tip end side of the arm 22. The boom 21, the arm 22, and the bucket 23 are driven by a boom cylinder 24, an arm cylinder 25, and a bucket cylinder 26, respectively, each composed of a hydraulic cylinder. The boom cylinder 24 allows the boom 21 to rotate with respect to the revolving frame 10, the arm cylinder 25 allows the arm 22 to rotate with respect to the boom 21, and the bucket cylinder 26 allows the bucket 23 to rotate with respect to the arm 22.

The boom cylinder 24, the arm cylinder 25, and the bucket cylinder 26, each serving as a hydraulic actuator, expand or contract based upon hydraulic oil (pressurized oil) from the later-described closed-circuit hydraulic pump 31 and the open-circuit hydraulic pump 40 to change the posture of the working mechanism 20. That is, the boom cylinder 24, the arm cylinder 25, and the bucket cylinder 26 expand or contract based upon the operation of the left control lever 13A and the right control lever 13B, for example, to rotate the boom 21, the arm 22, and the bucket 23, when the vehicle excavates earth and sand. The resulting operation of the bucket 23 can excavate earth and sand.

Herein, the boom cylinder 24, the arm cylinder 25, and the bucket cylinder 26 are each configured as a single rod-type hydraulic cylinder to expand or contract based upon the supply and discharge of hydraulic oil. That is, the boom cylinder 24, the arm cylinder 25, and the bucket cylinder 26 are each configured by a tube, a piston slidably inserted into the tube and defining the inside of the tube for a bottom side oil chamber and a rod side oil chamber, and a rod whose base end side is mounted on the piston and whose tip end side projects out of the tube.

Next, the configuration of closed circuit systems 27 to 30 and open circuit systems 36 to 39 will be described with reference to FIG. 5.

In this embodiment, a hydraulic system of the hydraulic excavator 1 is configured to allow the closed-circuit control valve device 32 to connect any one closed-circuit hydraulic pump 31 to any one hydraulic actuator in the form of a closed circuit (to configure a closed circuit) between four closed-circuit hydraulic pumps 31, and the four hydraulic actuators: the boom cylinder 24, the arm cylinder 25, the bucket cylinder 26 and the revolving hydraulic motors 3, 9. Then, a controller 55 controls the closed-circuit control valve device 32, depending on the situations of operations and work, to control the switching between each of the hydraulic actuators and each of the closed-circuit hydraulic pumps 31.

In this embodiment, the case where each of the closed-circuit hydraulic pumps 31 is connected to each of the hydraulic actuators to configure four closed circuit systems will be described. Specifically, the closed circuit system 27 is a hydraulic system for driving the boom cylinder 24. The closed circuit system 28 is a hydraulic system for driving the arm cylinder 25. The closed circuit system 29 is a hydraulic system for driving the bucket cylinder 26. Further, the closed circuit system 30 is a hydraulic system for driving the revolving hydraulic motors 8, 9. The configuration of these four most simplified closed circuit systems 27 to 30 will be described.

The closed circuit system 27 includes the closed-circuit hydraulic pumps 31 driven by the engine 14, and a later-described closed-circuit pump side pipe 45 and a closed-circuit actuator side pipe 47, each pipe connecting the closed-circuit hydraulic pumps 31 and the boom cylinder 24.

Herein, the configuration of the closed circuit systems 28 to 30 is generally the same as that of the closed circuit system 27. Thus, in the closed circuit systems 28 to 30, the component elements that are identical to those of the closed circuit system 27 will be denoted by the same reference numerals to avoid repetitions of similar explanations.

As shown in FIGS. 2 and 5, a plurality of, for example, four closed-circuit hydraulic pumps 31 that constitute the closed circuit systems 27 to 30 are mounted on the right side of the engine 14 (the power transmission device 15). The four closed-circuit hydraulic pumps 31 are configured by a swash plate type variable displacement hydraulic pump, an inclined shaft type hydraulic pump or a radial piston type hydraulic pump, for example. One end of a later-described closed-circuit pump side pipe 45 is connected to each of the four closed-circuit hydraulic pumps 31.

Subsequently, the configuration of the closed-circuit control valve device 32 and the open-circuit control valve device 41 that constitute the characterizing portion of an embodiment of the present invention will be described.

As shown in FIGS. 2 and 3, the closed-circuit control valve device 32 is located forward of the engine 14 and provided on the revolving frame 10. Also, the closed-circuit control valve device 32 is transversely disposed rearward of the left revolving hydraulic motor 8 to extend in the right-and-left direction. The closed-circuit control valve device 32 includes the later-described manifold 33, a control valve 34, and a filter 35.

The manifold 33 constitutes a base of the closed-circuit control valve device 32 and is mounted on the revolving frame 10. The manifold 33 is flat in the front-rear direction and formed as a rectangular block extending in the right-and-left direction and in the vertical direction. Accordingly, the width direction of the manifold 33 corresponds to the right-and-left direction. The manifold 33 has a lower surface 33A mounted on the revolving frame 10. The filter 35 is mounted on an upper surface 33B of the manifold 33.

Herein, the manifold 33 has a front surface 33C and a rear surface 33D that are opposite each other in the front-rear direction. The closed-circuit control valve 34 and a closed-circuit actuator side pipe 47 are mounted on the front surface 33C of the manifold 33 facing forward. Specifically, the front surface 33C includes a valve attachment area 33E for mounting a plurality of control valves 34 at a central portion in the right-and-left direction, that is, at a portion surrounded by a chain line in FIG. 4. The valve attachment area 33E is disposed just behind the left revolving hydraulic motor 8. The plurality of closed-circuit control valves 34 is mounted in the valve attachment area 33E in a concentrated manner.

In addition, the front surface 33C of the manifold 33 includes left and right pipe attachment areas 33F outward of the valve attachment area 33E in the right-and-left direction, that is, at both portions surrounded by a two-dot chain line and sandwiching the valve attachment area 33E in FIG. 4. A pipe joint port 33G is provided in the pipe attachment area 33F to serve as a supply and discharge port of pressure oil from the control valve 34 to each of the hydraulic actuators. The distance between the left and right pipe attachment areas 33F is set to be equivalent to or more than a dimension of the left revolving hydraulic motor 8 in the right-and-left direction. A plurality of closed-circuit actuator side pipes 47 is mounted on (connected to) a plurality of pipe joint ports 33G of the left and right pipe attachment areas 33F.

Further, the manifold 33 includes a plurality of oil passages (each not shown) communicating to a plurality of closed-circuit control valves 34 mounted in the valve attachment area 33E, a plurality of closed-circuit actuator side pipes 47 mounted in the pipe attachment area 33F and other elements.

The plurality of closed-circuit control valves 34 controls the boom cylinder 24, the arm cylinder 25 and the bucket cylinder 26 of the working mechanism 20, the revolving hydraulic motors 8, 9 of the revolving device 6 and the like. The plurality of control valves 34 is mounted on the front surface 33C and the rear surface 33D of the manifold 33. Specifically, the closed-circuit control valves 34 mounted on the front surface 33C of the manifold 33 are disposed in the valve attachment area 33E. In this way, a plurality of control valves 34 may be disposed at a central portion of the front surface 33C of the manifold 33 in a concentrated manner to form a space where a later-described closed-circuit actuator side pipe 47 is not distributed (not present), that is, a later-described first space 49 forward of the plurality of control valves 34.

The filter 35 is mounted on the upper surface 33B of the manifold 33. The filter 35 can prevent damage on a sliding portion of a hydraulic actuator or a valve by capturing foreign objects mixed in hydraulic oil.

Next, the open circuit system 36 is a hydraulic system for compensating for hydraulic oil relative to the closed circuit system 27. The open circuit system 37 is a hydraulic system for compensating for hydraulic oil relative to the closed circuit system 28. The open circuit system 38 is a hydraulic system for compensating for hydraulic oil relative to the closed circuit system 29. Further, the open circuit system 39 is a hydraulic system for compensating for hydraulic oil relative to the closed circuit system 30. In addition, the open circuit systems 36 to 39 supply hydraulic oil to the left and right traveling hydraulic motors 3, 4 as well.

The open circuit system 36 includes the open-circuit hydraulic pump 40 driven by the engine 14, a later-described open-circuit pump side pipe 46 connecting the open-circuit hydraulic pump 40 and the closed-circuit actuator side pipe 47, and the open-circuit actuator side pipe 48. Also, the open circuit system 36 is provided with a later-described open-circuit control valve 43 between the open-circuit pump side pipe 46 and the open-circuit actuator side pipe 48.

Herein, the configuration of the open circuit systems 37 to 39 is generally the same as that of the open circuit system 36. Thus, in the open circuit systems 37 to 39, the component elements that are identical to those of the open circuit system 36 will be denoted by the same reference numerals to avoid repetitions of similar explanations.

As shown in FIGS. 1 and 2, a plurality of, for example, four open-circuit hydraulic pumps 40 that constitute the open circuit systems 36 to 39 are mounted on the right side of the engine 14 (the power transmission device 15) together with the closed-circuit hydraulic pump 31. The four open-circuit hydraulic pumps 40 are configured by a swash plate type variable displacement hydraulic pump, an inclined shaft type hydraulic pump or a radial piston type hydraulic pump, for example.

The open-circuit control valve device 41 is located forward of the engine 14 and provided on the revolving frame 10. Specifically, the open-circuit control valve device 41 is transversely disposed to extend in the right-and-left direction so as to be closer to the right side of the revolving frame 10, that is, closer to the hydraulic oil tank 18 than the closed-circuit control valve device 32. The open-circuit control valve device 41 includes the later-described manifold 42, the control valve 43, and a filter 44, as in the closed-circuit control valve device 32.

The manifold 42 is flat in the front-rear direction and formed as a rectangular block extending in the right-and-left direction and in the vertical direction, as in the manifold 33. The manifold 42 has a lower surface 42A, an upper surface 42B, a front surface 42C, and a rear surface 42D, with the lower surface 42A mounted on the revolving frame 10. The filter 44 is mounted on the upper surface 42B.

Herein, as shown in FIG. 4, the front surface 42C of the manifold 42 facing forward is provided with a valve attachment area 42E surrounded by a chain line at a central portion in the right-and-left direction and including the plurality of control valves 43 mounted therein and a pipe attachment area 42F surrounded by a two-dot chain line outward of the valve attachment area 42E in the right-and-left direction and including therein a pipe joint port 42G serving as a supply and discharge port of pressure oil from the plurality of control valves 43 to each of the hydraulic actuators. The plurality of open-circuit control valves 43 is mounted in the valve attachment area 42E, and the plurality of open-circuit actuator side pipes 48 connected to the plurality of pipe joint ports 42G is mounted in the pipe attachment area 42F. The manifold 42 includes a plurality of oil passages (each not shown) communicating to the plurality of open-circuit control valves 43, the plurality of open-circuit actuator side pipes 48 and others.

The plurality of open-circuit control valves 43 controls the left traveling hydraulic motor 3, the right traveling hydraulic motor 4 and the like. The plurality of control valves 43 is mounted in the valve attachment area 42E of the front surface 42C of the manifold 42 and on the rear surface 42D of the manifold 42. In this way, the plurality of control valves 43 may be disposed at a central portion of the front surface 42C of the manifold 42 in a concentrated manner to form a space where a later-described open-circuit actuator side pipe 48 is not distributed, that is, a later-described third space 51 forward of the plurality of control valves 43.

The filter 44 is mounted on the upper surface 42B of the manifold 42. The filter 44 can prevent damage on a sliding portion of a hydraulic actuator or a valve by capturing foreign objects mixed in hydraulic oil, as in the filter 35. A later-described open-circuit pump side pipe 46 is connected to the filter 44.

A plurality of closed-circuit pump side pipes 45 connects the closed-circuit hydraulic pump 31 and the filter 35 of the closed-circuit control valve device 32. A plurality of open-circuit pump side pipes 46 connects the open-circuit hydraulic pump 40 and the filter 44 of the open-circuit control valve device 41.

A plurality of closed-circuit actuator side pipes 47 connects the closed-circuit control valve device 32, the boom cylinder 24, the arm cylinder 25 and the bucket cylinder 26 of the working mechanism 20, and the revolving hydraulic motors 8, 9 of the revolving device 6. One end of the plurality of closed-circuit actuator side pipes 47 is mounted on the front surface 33C of the manifold 33, and the other end extending forward of the front surface 33C is connected to the cylinders 24 to 26 of the working mechanism 20 and the revolving hydraulic motors 8, 9 of the revolving device 6 via a later-described joint block 52.

Herein, the plurality of closed-circuit actuator side pipes 47 is distributed to the left and right pipe attachment areas 33F provided on the front surface 33C of the manifold 33. In this case, with the left and right pipe attachment areas 33F disposed with an interval equivalent to or more than a dimension of the left revolving hydraulic motor 8 in the right-and-left direction, the plurality of closed-circuit actuator side pipes 47 extending forward of the front surface 33C is distributed to prevent contact with the left revolving hydraulic motor 8. The closed-circuit actuator side pipe 47 extending forward of the left pipe attachment area 33F passes on the left side of the left revolving hydraulic motor 8, and the closed-circuit actuator side pipe 47 extending forward of the right pipe attachment area 33F passes between the left revolving hydraulic motor S and the right revolving hydraulic motor 9 to extend forward.

In other words, the plurality of closed-circuit actuator side pipes 47 is distributed so as not to overlap the left revolving hydraulic motor 8 in plan view. This arrangement allows the plurality of closed-circuit actuator side pipes 47 not to be an obstacle to detachment and attachment of the left revolving hydraulic motor 8. That is, a first space 49 can be formed between the left and right distributed closed-circuit actuator side pipes 47 forward of the manifold 33.

A plurality of open-circuit actuator side pipes 48 connects the open-circuit control valve device 41, the left traveling hydraulic motor 3 and the right traveling hydraulic motor 4 of the lower traveling structure 2 and others. One end of the plurality of open-circuit actuator side pipes 48 is mounted on the front surface 42C of the manifold 42, and the other end extending forward of the front surface 42C is connected to the center joint 17 (the traveling hydraulic motors 3, 4) and the like via a joint block 52.

The plurality of open-circuit actuator side pipes 48 is distributed to the left and right pipe attachment areas 42F mounted on the front surface 42C of the manifold 42. The plurality of open-circuit actuator side pipes 48 mounted on the front surface 42C in the left pipe attachment area 42F is distributed so as not to overlap the right revolving hydraulic motor 9 in plan view by first bending rightward, then passing on the right side of the right revolving hydraulic motor 9 and extending forward. This arrangement allows the plurality of open-circuit actuator side pipes 48 not to be an obstacle to detachment and attachment of the right revolving hydraulic motor 9. That is, a second space 50 can be formed between the right closed-circuit actuator side pipe 47 and the left open-circuit actuator side pipe 48 forward of the manifold 42.

Further, the open-circuit actuator side pipe 48 mounted on the front surface 42C in the right pipe attachment area 42F linearly extends forward and then bends leftward. As a result, a third space 51 can be formed between the left open-circuit actuator side pipe 48 and the right open-circuit actuator side pipe 48 forward of the manifold 42.

The first space 49 is provided forward of the closed-circuit control valve device 32. The first space 49 is a space for detaching and attaching the left revolving hydraulic motor 8 and maintaining the control valve 34 of the closed-circuit control valve device 32. Specifically, the first space 49 separates the plurality of closed-circuit actuator side pipes 47 into the left closed-circuit actuator side pipe 47 extending forward of the left pipe attachment area 33F of the manifold 33 and the right closed-circuit actuator side pipe 47 extending forward of the right pipe attachment area 33F of the manifold 33. As a result, the first space 49 is formed as a space surrounded by the closed-circuit control valve device 32, the left closed-circuit actuator side pipe 47 and the right closed-circuit actuator side pipe 47.

In this case, the space for detaching and attaching the left revolving hydraulic motor 8 refers to a space for placing tools on bolts fixing the revolving hydraulic motor 8 to a reduction device (not shown) and lifting up the revolving hydraulic motor 8.

The second space 50 is provided forward of the open-circuit control valve device 41 and toward the left side thereof. The second space 50 is a space for detaching and attaching the right revolving hydraulic motor 9. Specifically, the second space 50 is surrounded by the above-described right closed-circuit actuator side pipe 47 and the left open-circuit actuator side pipe 48 that is bending forward of the left pipe attachment area 42F of the manifold 42 and then extending. The space for detaching and attaching the right revolving hydraulic motor 9 refers to a space for placing tools on bolts fixing the revolving hydraulic motor 9 to a reduction device (not shown) and lifting up the revolving hydraulic motor 9, as in the first space 49.

The third space 51 is located on the right side of the second space 50 and provided forward of the open-circuit control valve device 41. The third space 51 serves as a space for maintaining the control valve 43 of the open-circuit control valve device 41. Specifically, the third space 51 separates the plurality of open-circuit actuator side pipes 48 into the left open-circuit actuator side pipe 48 extending forward of the left pipe attachment area 42F of the manifold 42 and the right open-circuit actuator side pipe 48 extending forward of the right pipe attachment area 42F of the manifold 42. As a result, the third space 51 is formed as a space surrounded by the open-circuit control valve device 41, the left open-circuit actuator side pipe 48 and the right open-circuit actuator side pipe 48.

The joint block 52 is provided near a base end portion of the boom 21 of the working mechanism 20, for example. The joint block 52 constitutes a joint collectively fixing a connecting portion of the plurality of closed-circuit actuator side pipes 47 and a connecting portion of the plurality of open-circuit actuator side pipes 48.

One closed-circuit tank side pipe 53 connects the closed-circuit control valve device 32 and the hydraulic oil tank 18. The closed-circuit tank side pipe 53 is a pipe returning hydraulic oil to the hydraulic oil tank 18 and is distributed above the open-circuit control valve device 41. This arrangement allows the closed-circuit tank side pipe 53 not to be an obstacle for an operator to work on the third space 51.

The open-circuit tank side pipe 54 connects the open-circuit control valve device 41 and the hydraulic oil tank 18. The open-circuit tank side pipe 54 is a pipe returning hydraulic oil to the hydraulic oil tank 18 and a plurality thereof is provided.

The controller 55 is connected to the operating device 13, the plurality of control valves 34 of the closed-circuit control valve device 32 and the control valve 43 of the open-circuit control valve device 41 via signal lines. The controller 55 switches between the control valves 34, 43 based upon a signal from the operating device 13.

The hydraulic excavator 1 of this embodiment is configured as described above, and subsequently, the operation of the hydraulic excavator 1 will be explained.

An on-board operator in the cab 11 starts the engine 14 to drive the closed-circuit hydraulic pump 31 and the open-circuit hydraulic pump 40. In this state, the operator can advance or retreat the lower traveling structure 2 by operating the left and right traveling levers/pedals 13C, 13D. Meanwhile, the operator can perform excavating work of earth and sand by operating the left working control lever 13A and the right working control lever 13B to rotate the working mechanism 20.

Thus, in this embodiment, the closed-circuit control valve device 32 includes the plurality of closed-circuit control valves 34 located on the front surface 33C of the manifold 33 facing forward and the plurality of pipe joint ports 33G located on the front surface 33C of the manifold 33 and connected by the plurality of closed-circuit actuator side pipes 47, and is disposed rearward of the left revolving hydraulic motor 8 such that the front surface 33C of the manifold 33 faces the left revolving hydraulic motor 8. Also, the front surface 33C of the manifold 33 includes the valve attachment area 33E provided at a central portion of the manifold 33 in the right-and-left direction and including the plurality of control valves 34 mounted therein and the pipe attachment area 33F provided outward of the valve attachment area 33E in the right-and-left direction and including the plurality of closed-circuit actuator side pipes 47 mounted on the pipe joint ports 33G.

Meanwhile, the open-circuit control valve device 41 includes the plurality of open-circuit control valves 43 located on the front surface 42C of the manifold 42 facing forward and the plurality of pipe joint ports 42G located on the front surface 42C of the manifold 42 and connected by the plurality of open-circuit actuator side pipes 48, and is disposed rearward of the right revolving hydraulic motor 9 such that the front surface 42C of the manifold 42 faces the right revolving hydraulic motor 9. Also, the front surface 42C of the manifold 42 includes the valve attachment area 42E provided at a central portion of the manifold 42 in the right-and-left direction and mounted the plurality of control valves 43 and the pipe attachment area 42F provided outward of the valve attachment area 42E in the right-and-left direction and provided the pipe joint ports 42G mounted the plurality of open-circuit actuator side pipes 48.

Accordingly, the closed-circuit actuator side pipe 47 extending forward of the left pipe attachment area 33F of the manifold 33 passes on the left side of the left revolving hydraulic motor 8, and the closed-circuit actuator side pipe 47 extending forward of the right pipe attachment area 33F passes on the right side of the left revolving hydraulic motor 8. This arrangement can prevent the plurality of closed-circuit actuator side pipes 47 from being distributed in contact with the left revolving hydraulic motor 8 in plan view.

The open-circuit actuator side pipe 48 extending forward of the left pipe attachment area 42F of the manifold 42 passes on the right side of the right revolving hydraulic motor 9. This arrangement can prevent the plurality of open-circuit actuator side pipes 48 from being distributed in contact with the right revolving hydraulic motor 9 in plan view.

Further, the open-circuit actuator side pipe 48 extending forward of the right pipe attachment area 42F of the manifold 42 has an interval with the open-circuit actuator side pipe 48 extending forward of the left pipe attachment area 42F in right-and-left direction. This arrangement can prevent the plurality of open-circuit actuator side pipes 48 from being distributed forward of the open-circuit control valve 43.

As a result, a space for detaching and attaching and maintaining the control valves 34, 43 mounted on the control valve devices 32, 41 and the revolving hydraulic motors 8, 9 disposed near the control valve devices 32, 41 and the like can be secured. Consequently, operations detaching the plurality of actuator side pipes 47, 48 can be saved to enhance the operational efficiency for detaching and attaching and maintaining the control valves 34, 43, the revolving hydraulic motors 8, 9 and the like.

The plurality of closed-circuit actuator side pipes 47 is distributed such that a working space can be secured above the left revolving hydraulic motor 8 and forward of the valve attachment area 33E, so as to start at the pipe attachment area 33F on the front surface 33C of the manifold 33, bypass the space above the left revolving hydraulic motor 8 and travel forward. This arrangement allows a working space to be secured above the left revolving hydraulic motor 8 and forward of the valve attachment area 33E. Meanwhile, the plurality of open-circuit actuator side pipes 48 is distributed such that a working space can be secured above the right revolving hydraulic motor 9 and forward of the valve attachment area 42E, so as to start at the pipe attachment area 42F on the front surface 42C of the manifold 42, bypass the space above the right revolving hydraulic motor 9 and travel forward. This arrangement allows a working space to be secured above the right revolving hydraulic motor 9 and forward of the valve attachment area 42E.

The construction machine according to the present invention includes the closed circuit systems 27 to 30 supplying and discharging hydraulic oil between the closed-circuit hydraulic pump 31 and the hydraulic actuators including the boom cylinder 24, the arm cylinder 25 and the bucket cylinder 26 of the working mechanism 20 and the revolving hydraulic motors 8, 9 of the revolving device 6, and the open circuit systems 36 to 39 supplying hydraulic oil of the hydraulic oil tank 18 provided on the revolving frame 10 from the open-circuit hydraulic pump 40 to the traveling hydraulic motors 3, 4 of the lower traveling structure 2 different from each of the cylinders 24 to 26 of the working mechanism 20 and the revolving hydraulic motors 8, 9 of the revolving device 6. In addition, the control valve device is composed of the closed-circuit control valve device 32 connected to the closed circuit systems 27 to 30 and the open-circuit control valve device 41 connected to the open circuit systems 36 to 39. Additionally, the open-circuit control valve device 41 is disposed to be closer to the hydraulic oil tank 18 than the closed-circuit control valve device 32.

Herein, the closed-circuit control valve device 32 is connected to the hydraulic oil tank 18 by one closed-circuit tank side pipe 53. Meanwhile, the open-circuit control valve device 41 is connected to the hydraulic oil tank 18 by a plurality of open-circuit tank side pipes 54. Accordingly, the arrangement of the open-circuit control valve device 41 having many open-circuit tank side pipes 54 connected to the hydraulic oil tank 18 near the hydraulic oil tank 18 allows the total length dimension of the closed-circuit tank side pipe 53 and the plurality of open-circuit tank side pipes 54 to be shortened. As a result, the tank side pipes 53, 54 can be simplified in layout, with reduced costs.

The plurality of closed-circuit actuator side pipes 47 is distributed such that the first space 49 capable of detaching and attaching the left revolving hydraulic motor 8 and maintaining the control valve 34 of the closed-circuit control valve device 32 can be provided forward of the closed-circuit control valve device 32 and the second space 50 capable of detaching and attaching the right revolving hydraulic motor 9 and the third space 51 capable of maintaining the control valve 43 of the open-circuit control valve device 41 can be secured forward of the open-circuit control valve device 41, so as to start at the pipe attachment area 33F on the front surface 33C of the manifold 33 of the closed-circuit control valve device 32, bypass the space forward of the valve attachment area 33E and above the left revolving hydraulic motor 8 and travel forward, and so as to start at the pipe attachment area 42F on the front surface 42C of the manifold 42 of the open-circuit control valve device 41, bypass the space forward of the valve attachment area 42E and above the right revolving hydraulic motor 9 and travel forward. This arrangement can detach and attach the left revolving hydraulic motor 8 and maintain the control valve 34 of the closed-circuit control valve device 32 in the first space 49. Also, the right revolving hydraulic motor 9 can be detached and attached in the second space 50. Further, the control valve 43 of the open-circuit control valve device 41 can be maintained in the third space 51.

The closed-circuit tank side pipe 53 connecting the closed-circuit control valve device 32 and the hydraulic oil tank 18 is provided. The closed-circuit tank side pipe 53 is distributed above the open-circuit control valve device 41. This arrangement allows the closed-circuit tank side pipe 53 not to be an obstacle for an operator to work in the third space 51, thereby enhancing the operational efficiency for maintaining the control valve 43 of the open-circuit control valve device 41 in the third space 51.

In the embodiment, the case where the closed-circuit control valve device 32 and the open-circuit control valve device 41 are provided side by side in the right-and-left direction on the revolving frame 10 is illustrated. However, the present invention is not limited to that, and for example, one common manifold is provided and the control valve of the closed-circuit control valve device and the control valve of the open-circuit control valve device may be configured to be mounted on the common manifold. Alternatively, three or more control valve devices may be configured to be provided.

The embodiments are explained by taking the example where a hydraulic excavator 1 with a backhoe-type working mechanism 20 is illustrated as a construction machine. However, the present invention is not limited to that, and may be widely employed in other types of construction machines such as a hydraulic excavator with a loading shovel-type working mechanism.

### DESCRIPTION OF REFERENCE NUMERALS

1: Hydraulic excavator (Construction machine)
2: Lower traveling structure
3: Left traveling hydraulic motor (Hydraulic actuator)
4: Right traveling hydraulic motor (Hydraulic actuator)
5: Upper revolving structure
6: Revolving device
8: Left revolving hydraulic motor (Hydraulic actuator)
9: Right revolving hydraulic motor (Hydraulic actuator)
10: Revolving frame
14: Engine (Prime mover)
18: Hydraulic oil tank
20: Working mechanism
24: Boom cylinder (Hydraulic actuator)
25: Arm cylinder (Hydraulic actuator)
26: Bucket cylinder (Hydraulic actuator)
27 to 30: Closed circuit system
31: Closed-circuit hydraulic pump
32: Closed-circuit control valve device (Control valve device)
33, 42: Manifold
33C, 42C: Front surface
33E, 42E: Valve attachment area
33F, 42F: Pipe attachment area
33G, 42G: Pipe joint port
34, 43: Control valve
36 to 39: Open circuit system
40: Open-circuit hydraulic pump
41: Open-circuit control valve device (Control valve device)
45: Closed-circuit pump side pipe
46: Open-circuit pump side pipe
47: Closed-circuit actuator side pipe
48: Open-circuit actuator side pipe
49: First space
50: Second space
51: Third space
53: Closed-circuit tank side pipe
54: Open-circuit tank side pipe

1.-5. (canceled)

6. A construction machine comprising:
a self-propelled lower traveling structure comprising a crawler belt rotated by a traveling hydraulic motor; an upper revolving structure provided rotatably on the lower traveling structure via a revolving device; a working mechanism provided rotatably at a front portion of the upper revolving structure and includes a boom, an arm and a bucket respectively each rotated by a boom cylinder, an arm cylinder and a bucket cylinder respectively each composed of a hydraulic cylinder; and a hydraulic system driving the lower traveling structure, the upper revolving structure and the working mechanism, wherein
the revolving device comprises:
a revolving ring supporting rotatably the upper revolving structure on the lower traveling structure; and
a revolving hydraulic motor provided on the upper revolving structure and revolving the upper revolving structure on the lower traveling structure along the revolving ring, wherein
the hydraulic system comprises:
a closed circuit system supplying and discharging hydraulic oil between respectively each of the boom cylinder, the arm cylinder, the bucket cylinder and the revolving hydraulic motor as hydraulic actuators,
an open circuit system supplying hydraulic oil to the closed circuit system and the traveling hydraulic motor as the hydraulic actuators, and supplying hydraulic oil from a hydraulic oil tank to each of the hydraulic actuators, wherein
the upper revolving structure comprises:
a revolving frame supported rotatably on the lower traveling structure via the revolving ring;
a prime mover provided on a rear side of the revolving frame;
a plurality of closed circuit hydraulic pumps and a plurality of open-circuit hydraulic pumps driven by the prime mover and included in the closed circuit system and the open circuit system respectively;
a control valve device located forward of the prime mover, the plurality of closed circuit hydraulic pumps and the plurality of open-circuit hydraulic pumps, provided on the revolving frame and composed of a plurality of control valves mounted on a rectangular manifold;
a plurality of pump side pipes connecting the plurality of closed circuit hydraulic pumps, the plurality of open-circuit hydraulic pumps and the control valve device; and
a plurality of actuator side pipes connecting the control valve device, the boom cylinder, the arm cylinder, the bucket cylinder of the working mechanism, the revolving hydraulic motor of the revolving device and the traveling hydraulic motor, wherein
the control valve device comprises the plurality of control valves located on a front surface of the manifold facing forward and a plurality of pipe joint ports located on the front surface of the manifold and connected to the plurality of actuator side pipes, and is disposed rearward of the revolving hydraulic motor such that the front surface of the manifold faces the revolving hydraulic motor, and
a valve attachment area is provided at a central portion of the manifold in the right-and-left direction of the front surface of the manifold and mounted the plurality of control valves,
pipe attachment areas are provided outward of the valve attachment area in the right-and-left direction sandwiching between the valve attachment area of the front surface of the manifold and each provided the pipe joint ports mounted the plurality of actuator side pipes extending forward of the manifold, and
the plurality of pump side pipes is connecting from above to the upper surface of manifold.

7. The construction machine according to claim 6, wherein
the plurality of actuator side pipes is distributed such that a working space can be secured above the revolving hydraulic motor and forward of the valve attachment area, so as to start at the pipe attachment area on the front surface of the manifold, bypass the space above the revolving hydraulic motor and travel forward.

8. The construction machine according to claim 6, wherein
the control valve device is composed of a closed-circuit control valve device connected to the closed circuit system and an open-circuit control valve device connected to the open circuit system, and
the open-circuit control valve device is located to be closer to the hydraulic oil tank than the closed-circuit control valve device.

9. The construction machine according to claim 8, wherein
the plurality of actuator side pipes is distributed such that:
a first space capable of detaching and attaching the revolving hydraulic motor and maintaining the control valve of the closed-circuit control valve device can be provided forward of the closed-circuit control valve device, and
a second space capable of detaching and attaching the revolving hydraulic motor and a third space capable of maintaining the control valve of the open-circuit control valve device can be provided forward of the open-circuit control valve device,
so as to start at the pipe attachment area on the front surface of the manifold of the closed-circuit control valve device and the open-circuit control valve device, bypass the space forward of the valve attachment area and above the revolving hydraulic motor and travel forward.

10. The construction machine according to claim 8, comprising
a closed-circuit tank side pipe connecting the closed-circuit control valve device and the hydraulic oil tank, wherein
the closed-circuit tank side pipe is distributed above the closed-circuit control valve device.
